(19) United States
(12) Patent Application Publication
(10) Pub. No.: US 2023/0231274 A1
(43) Pub. Date: Jul. 20, 2023

(54) BATTERY

(71) Applicant: MURATA MANUFACTURING CO., LTD., Kyoto (JP)

(72) Inventors: Hiroshi HORIUCHI, Kyoto (JP); Masayuki IHARA, Kyoto (JP)

(21) Appl. No.: 18/127,253

(22) Filed: Mar. 28, 2023

Related U.S. Application Data
(63) Continuation of application No. PCT/JP2021/039484, filed on Oct. 26, 2021.

(30) Foreign Application Priority Data
Nov. 24, 2020 (JP) 2020-194089

(51) Int. Cl. H01M 50/46; H01M 50/547; H01M 50/564

(52) U.S. Cl. CPC H01M 50/46; H01M 50/547; H01M 50/564

(57) ABSTRACT

Provided is a battery having both high impact resistance and high heat resistance.

Provided is a battery including: a battery element in which a positive electrode and a negative electrode are laminated with a separator interposed therebetween; a fixing member disposed on an end face where a laminated surface of the battery element is exposed; and a tab led out from one end face of the battery element, wherein the separator protrudes from the end face of the battery element, the separator is mutually fused with at least a protruding portion of one of the one end face or another end face opposite to the one end face; and the separator positioned around the tab on the one end face is not mutually fused with the one end face.

### CROSS REFERENCE TO RELATED APPLICATIONS

The present application is a continuation of PCT application no. PCT/JP2021/039484, filed on Oct. 26, 2021, which claims priority to Japanese patent application no. JP2020-194089, filed on Nov. 24, 2020, the entire contents of which are herein incorporated by reference.

### BACKGROUND

The present application relates to a battery.

An electronic device using a battery as a power source is used for various purposes, and is often carried and used. Accordingly, there is a need for such structure of the battery or the electronic device that resists an external load due to falling or heat and the like.

A battery is described in which a separator protruding from an end portion of a positive electrode and an end portion of a negative electrode is fused with at least one or more end faces for fixing a wound battery element.

### SUMMARY

The present application relates to a battery.

However, in the battery described in Background, there are problems that fixing of the wound battery element or a laminated battery element is inappropriate, and that the wound battery element or the laminated battery element is weak against the external load including falling or heat and the like.

Accordingly, the present application relates to providing a battery having both high impact resistance and high heat resistance according to an embodiment.

A battery according to an embodiment of the present application includes:

a battery element in which a positive electrode and a negative electrode are laminated with a separator interposed therebetween;

a fixing member disposed on an end face where a laminated surface of the battery element is exposed; and

a tab led out from one end face of the battery element, in which

the separator protrudes from the end face of the battery element;

the separator is mutually fused with at least a protruding portion of one of the one end face or another end face opposite to the one end face; and

the separator positioned around the tab on the one end face is not mutually fused with the one end face.

According to an embodiment of the present application, a thermal runaway can be suppressed under a high-temperature condition, and a damage to an exterior member or a power storage device caused by the external load including falling or heat and the like can be suppressed. In addition, contents of the present application are not to be construed as being limited by effects exemplified in the present description.

### BRIEF DESCRIPTION OF THE FIGURES

FIG. 1 is an exploded perspective view of a wound battery in an embodiment.

FIG. 2 is a schematic sectional view of the wound battery element in an embodiment.

FIG. 3 is an exploded perspective view of a laminated battery in an embodiment.

FIG. 4 is a schematic sectional view of the laminated battery element in an embodiment.

FIG. 5 is an example of a perspective view of a wound battery element in examples and comparative examples.

FIG. 6 is an example of a perspective view of a laminated battery element in the examples and the comparative examples.

FIG. 7 illustrates views A and B for explaining a fusion of a separator in the examples and the comparative examples.

FIG. 8 is a view for explaining the fusion of the separator in the examples and the comparative examples.

FIG. 9 is another example of the perspective view of the wound battery element in the comparative examples.

FIG. 10 illustrates views A to F that are plan views of the wound battery element, and are views for explaining Examples 1 to 3 and Comparative Examples 1 to 8.

FIG. 11 is another example of the perspective view of the laminated battery element in the comparative examples.

FIG. 12 illustrates views A to F that are plan views of the laminated battery element, and are views for explaining Examples 4 to 5 and Comparative Example 9 to 17.

### DETAILED DESCRIPTION

Hereinafter, the present application will be described in further detail including with reference to the drawings and one or more examples according to an embodiment.

A battery according to an embodiment include two types: a wound battery in which the positive electrode and the negative electrode are laminated and wound with a separator interposed therebetween; and a laminated battery in which the positive electrode and the negative electrode are alternately laminated with the separator interposed therebetween. Hereinafter, the wound battery and the laminated battery will be further described according to an embodiment.

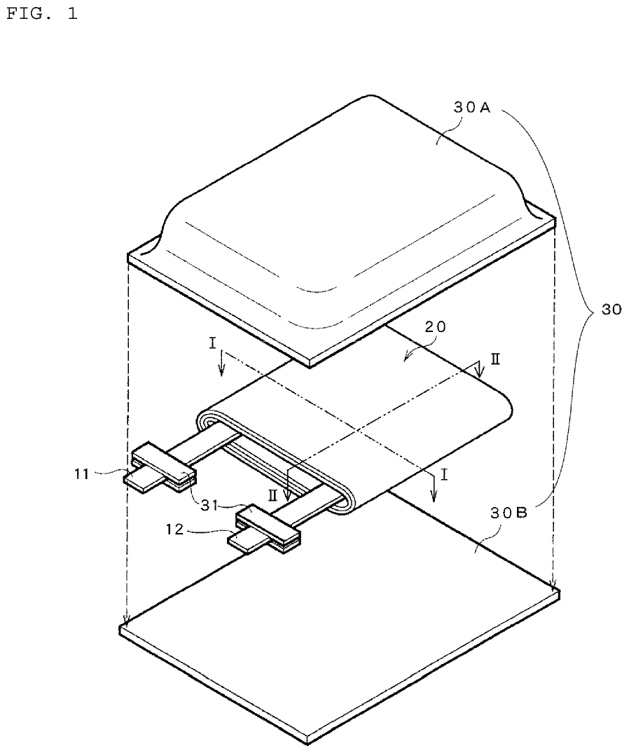

FIG. 1 is an exploded perspective view showing an example of the wound battery using a laminated material, which is an example of the battery of the present application. The battery shown in the drawings is made by enclosing a wound battery element 20 to which tabs 11 and 12 are attached in film-like exterior members 30 (30A and 30B). In an embodiment, for example, the tab 11 is a positive electrode tab and the tab 12 is a negative electrode tab, but they may be reversed. The tab 11 and the tab 12 are both led out from inside to outside of the exterior members 30, for example, in the same direction. The tab 11 and the tab 12 may each be led in opposite directions. The tab 11 and the tab 12 are each made of a metal material such as aluminum (Al), copper (Cu), nickel (Ni), or stainless steel.

The exterior members 30 are formed of, for example, a rectangular laminated film obtained by bonding a nylon film, an aluminum foil, and a polyethylene film in this order. The exterior members 30 are disposed such that, for example, a polyethylene film side and a wound battery element 20 face each other, and outer edge portions thereof are joined to each other by a fusion or an adhesive.

A close contact film 31 for preventing an entry of outside air is inserted among the exterior members 30 and the tab 11 as well as the tab 12. The close contact film 31 is made of a material having adhesion to the tab 11 and the tab 12, and for example, when the tab 11 and the tab 12 are made of the metal material described above, the close contact film is preferably made of polyolefin resin such as polyethylene, polypropylene, modified polyethylene, or modified polypropylene.

In addition, the exterior members 30 may be formed of another structure, for example, a laminated film having no metal material, a polymer film such as polypropylene, or a metal film, and the like, instead of the laminated film described above. Here, a general configuration of the exterior member can be represented by a laminated structure of an exterior layer/a metal foil/a sealant layer (however, the exterior layer and the sealant layer may be formed of a plurality of layers), and in the example above, the nylon film corresponds to the exterior layer, the aluminum foil corresponds to the metal foil, and the polyethylene film corresponds to the sealant layer. In addition, as the metal foil, it is sufficient that the metal foil functions as a moisture-permeable barrier film, and not only the aluminum foil but also a stainless steel foil, a nickel foil, a plated iron foil, and the like can be used, but a thin and lightweight aluminum foil having excellent processability can be suitably used.

As the exterior member, when usable configurations are listed in forms of (the exterior layer/the metal foil/the sealant layer), there are Ny (nylon)/Al (aluminum)/CPP (cast polypropylene), PET (polyethylene terephthalate)/Al/CPP, PET/Al/PET/CPP, PET/Ny/Al/CPP, PET/Ny/Al/Ny/CPP, PET/Ny/Al/Ny/PE (polyethylene), Ny/PE/Al/LLDPE (linear low density polyethylene), PET/PE/Al/PET/LDPE (low density polyethylene), and PET/Ny/Al/LDPE/CPP and the like.

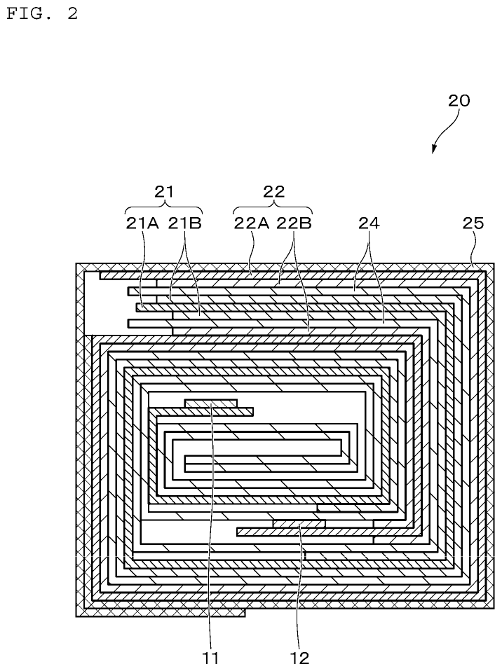

FIG. 2 is a sectional view taken along a line I-I of the wound battery element 20 shown in FIG. 1. In the drawing, a positive electrode 21 and a negative electrode 22 are positioned to face each other with a separator 24 interposed therebetween and are wound, and the outermost peripheral portion is protected by a protective tape 25 in the wound battery element 20. The wound battery element 20 is filled with a non-aqueous electrolytic solution (not illustrated), and the positive electrode 21, the negative electrode 22, and the separator 24 are impregnated within the non-aqueous electrolytic solution.

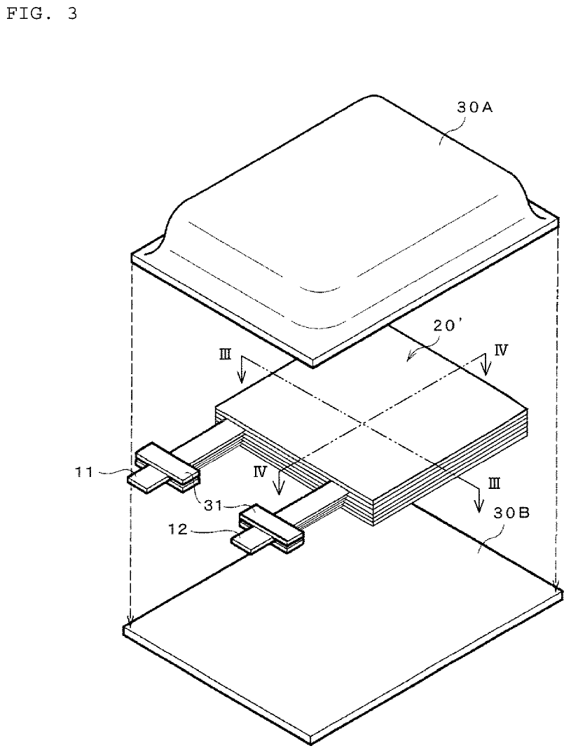

Here, FIG. 3 is an exploded perspective view showing a laminated battery using the laminated material, being another example of the battery of the present application. In addition, substantially same members as those of the wound battery described above are denoted by same reference numbers, and a description thereof will be omitted. As shown in FIG. 3, the laminated battery has a substantially same configuration as the wound battery shown in FIG. 1 except that the laminated battery includes a laminated battery element 20′ instead of the wound battery element 20.

The laminated battery element 20′ has a laminated structure in which a sheet-like positive electrode and a sheet-like negative electrode are positioned to face each other with the separator interposed therebetween, and for example, the negative electrode sheet, the separator, and the positive electrode sheet are laminated in this order. As in a case of the wound battery element 20, the laminated battery element 20′ is filled with the non-aqueous electrolytic solution (not illustrated), and the positive electrode 21, the negative electrode 22, and the separator 24 are impregnated within the non-aqueous electrolytic solution.

As shown in FIG. 2, the positive electrode 21 has a structure in which, for example, both surfaces or one surface of a positive electrode current collector 21A having a pair of opposing surfaces are coated with a positive electrode active material layer 21B. The positive electrode current collector 21A has a portion exposed without being coated with the positive electrode active material layer 21B at one end portion in a longitudinal direction, and the tab 11 is attached to the exposed portion.

The positive electrode current collector 21A is made of the metal foil such as the aluminum foil, the nickel foil, or the stainless steel foil. The positive electrode active material layer 21B contains any one kind or two or more kinds of positive electrode materials capable of occluding and releasing lithium ions as a positive electrode active material, and may contain a conductive material and a binder as necessary.

Examples of the positive electrode material include lithium-containing compounds. Examples of such lithium-containing compounds include composite oxides containing lithium and transition metal elements and phosphate compounds containing the lithium and the transition metal elements, and from a viewpoint of obtaining a higher voltage, compounds containing cobalt (Co), nickel (Ni), manganese (Mn), iron (Fe), copper (Cu), zinc (Zn), chromium (Cr), vanadium (V), titanium (Ti), or any mixture thereof are preferable.

Such lithium-containing compounds are typically represented by a general formula (1) or (2) below,

LiₓM^{I}O₂ (1)

Li_{y}M^{II}PO₂ (2)

wherein M^{I} and M^{II} in the formula represent one or more kinds of the transition metal elements, and values of x and y vary depending on a charge/discharge state of the battery, but usually 0.05≤x≤1.10 and 0.05≤y≤1.10; and compounds represented by the formula (1) generally have the laminated structure, and compounds represented by the formula (2) generally have an olivine structure.

Further, specific examples of the composite oxides containing the lithium and the transition metal elements include lithium-cobalt composite oxides (LiₓCoO₂), lithium-nickel composite oxides (LiₓNiO₂), lithium-nickel-cobalt composite oxides (LiₓNi_{1-z}Co_{z}O₂ (0<z<1)), and lithium-manganese composite oxides having a spinel-type structure (LiMn₂O₄).

Specific examples of the phosphate compounds containing the lithium and the transition metal elements include lithium iron phosphate compounds (LiFePO₄) or lithium iron manganese phosphate compounds (LiFe₁₋ᵥMnᵥPO₄ (v<1)) having the olivine structure. In these composite oxides, for a purpose of stabilizing the structure, for example, composite oxides in which a part of the transition metals are substituted with Al, Mg, or other transition metal elements or contained in crystal grain boundaries, composite oxides in which a part of oxygen is substituted with fluorine or the like, and the like can also be exemplified. Furthermore, at least a part of a surface of the positive electrode active material may be coated with another positive electrode active material. Further, a plurality of kinds of positive electrode active materials may be mixed and used.

On the other hand, similarly to the positive electrode 21, the negative electrode 22 has, for example, a structure in which a negative electrode active material layer 22B is provided on both sides or one side of a negative electrode current collector 22A having a pair of opposing surfaces. The negative electrode current collector 22A has an exposed portion where the negative electrode active material layer 22B is not provided at one end portion in the longitudinal direction, and the tab 12 is attached to the exposed portion.

The negative electrode current collector 22A is made of the metal foil such as a copper foil, the nickel foil, or the stainless steel foil. The negative electrode active material layer 22B contains, as a negative electrode active material, any one or two or more of metallic lithium and negative electrode materials capable of occluding and releasing the lithium ions, and may contain the conductive material or the binder as necessary. Examples of the negative electrode material capable of occluding and releasing the lithium include a carbon material, a metal oxide, and a polymer compound. Examples of the carbon material include non-graphitizable carbon materials, artificial graphite materials, and graphite-based materials, and the like, and more specific examples thereof include pyrolytic carbons, cokes, graphite, glassy carbons, organic polymer compound fired bodies, carbon fibers, activated carbon, carbon black, and the like.

Among them, the cokes include pitch coke, needle coke, petroleum coke, and the like, and the organic polymer compound fired bodies refer to carbonized products obtained by firing polymer materials such as phenol resin or furan resin at an appropriate temperature. Further, examples of the metal oxide include iron oxide, ruthenium oxide, molybdenum oxide, and the like, and examples of the polymer compound include polyacetylene, polypyrrole, and the like.

Furthermore, examples of the negative electrode material capable of occluding and releasing the lithium include materials containing at least one of metal elements and metalloid elements capable of forming alloys with lithium as constituent elements. The negative electrode material may be simple substances, the alloys, or compounds of the metal elements or metalloid elements, or may have one or two or more phases thereof in at least a part thereof. In addition, in the present application, the alloys include alloys containing one or more metal elements and one or more metalloid elements in addition to alloys containing two or more metal elements. Further, nonmetallic elements may also be contained. A structure thereof includes a solid solution, a eutectic (a eutectic mixture), intermetallic compounds, or a structure in which two or more thereof coexist.

Examples of such metal elements or metalloid elements include tin (Sn), lead (Pb), aluminum, indium (In), silicon (Si), zinc (Zn), antimony (Sb), bismuth (Bi), gallium (Ga), germanium (Ge), arsenic (As), silver (Ag), hafnium (Hf), zirconium (Zr), and yttrium (Y). Among them, metal elements or metalloid elements of Group 14 in a long periodic table are preferable, and silicon or tin are particularly preferable. This is because silicon and tin have a high ability to occlude and release the lithium and a high energy density can be obtained.

Examples of silicon alloys include alloys containing, as a second constituent element other than silicon, at least one of a group consisting of tin, magnesium, nickel, copper, iron, cobalt, manganese, zinc, indium, silver, titanium, germanium, bismuth, antimony, and chromium.

Further, the separator 24 is formed by an insulating thin film having a high ion permeability and a predetermined mechanical strength, such as a porous film made of a polyolefin-based synthetic resin like polypropylene (a melting point: around 165° C.) or polyethylene (a melting point: around 135° C.), or a porous film made of an inorganic material such as a ceramic nonwoven fabric, and may have a structure in which two or more kinds of these porous films are laminated. In particular, those containing a polyolefin-based porous film are suitable because they are excellent in separability between the positive electrode 21 and the negative electrode 22, and can further reduce internal short circuit and reduction in open circuit voltage.

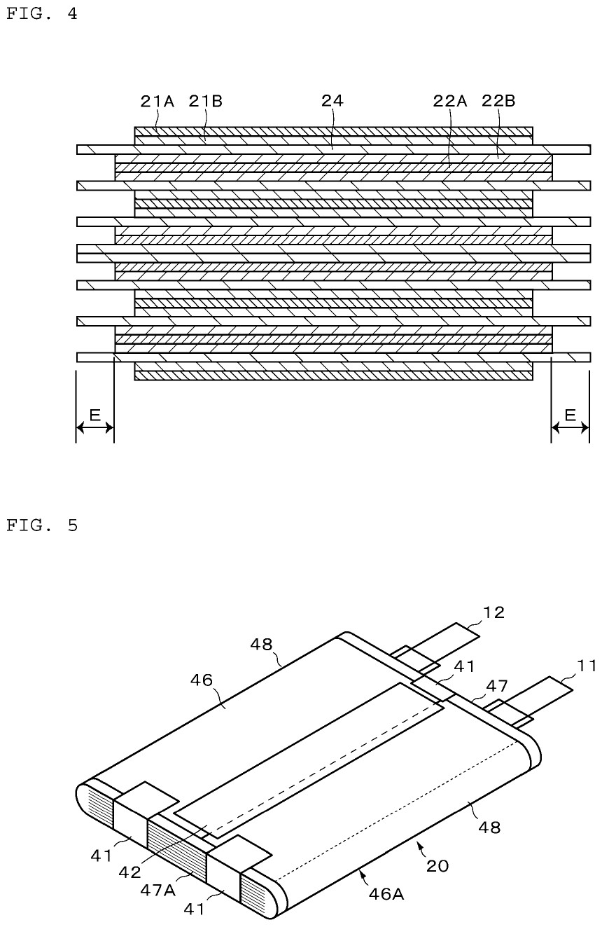

FIG. 4 is a section parallel to a winding direction of the wound battery element 20 shown in FIG. 1, that is, a sectional view taken along line II-II (the same applies to sectional views taken along line III-III or line IV-IV of the laminated battery element 20′ shown in FIG. 3), and in the battery of the present application, the separator 24 is disposed so that an end portion protrudes from ends of the positive electrode 21 and the negative electrode 22 by a predetermined length E.

In addition, a protrusion length E of the separator 24 needs to be 0.3 mm or more from a viewpoint of causing thermal fusion as described above, while the thermal fusion is further ensured; however, when the protrusion length is too large, volume loss of the portion increases; and thus it is desirable to control the protrusion length within a range of 0.5 to 1.0 mm.

The non-aqueous electrolytic solution may contain an electrolyte salt and a non-aqueous solvent. Here, as the electrolyte salt, any electrolyte salt may be used as long as it is dissolved or dispersed in the non-aqueous solvent to be described later to generate ions, and lithium hexafluorophosphate (LiPF₆) can be suitably used, but it is needless to say that the electrolyte salt is not limited thereto.

In other words, inorganic lithium salts such as lithium tetrafluoroborate (LiBF₄), lithium hexafluoroarsenate (LiAsF₆), lithium hexafluoroantimonate (LiSbF₆), lithium perchlorate (LiClO₄), and lithium tetrachloroaluminate (LiAlCl₄), lithium salts of perfluoroalkanesulfonic acid derivatives such as lithium trifluoromethanesulfonate (LiCF₃SO₃), lithium bis (trifluoromethanesulfone) imide (LiN(CF₃SO₂)₂), lithium bis (pentafluoromethanesulfone) methide (LiN(C₂F₅SO₂)₂), and lithium tris (trifluoromethanesulfone) methide (LiC(CF₃SO₂)₃), and the like can also be used alone or in combination of two or more kinds thereof.

In addition, contents of such electrolyte salt are preferably in a range of 0.1 mol to 3.0 mol, and more preferably in a range of 0.5 mol to 2.0 mol, with respect to 1 liter (l) of the solvent. This is because higher ion conductivity can be obtained within this range.

Further, examples of the non-aqueous solvent include various high dielectric constant solvents and low viscosity solvents. As the high dielectric constant solvents, ethylene carbonate, propylene carbonate, and the like can be suitably used, but they are not limited thereto, and cyclic carbonates such as butylene carbonate, vinylene carbonate, 4-fluro-1,3-dioxolane-2-one (fluoroethylene carbonate), 4-chloro-1,3-dioxolane-2-one (chloroethylene carbonate), and trifluoromethyl ethylene carbonate can be used.

Further, as the high dielectric constant solvents, lactones such as γ-butyrolactone and γ-valerolactone, lactams such as N-methylpyrrolidone, cyclic carbamic acid esters such as N-methyloxazolidinone, and sulfone compounds such as tetramethylene sulfone can also be used in place of or in combination with the cyclic carbonates.

On the other hand, as the low viscosity solvents, diethyl carbonate can be suitably used, but in addition to this, chain carbonates such as dimethyl carbonate, ethyl methyl carbonate, and methyl propyl carbonate; chain carboxylic acid esters such as methyl acetate, ethyl acetate, methyl propionate, ethyl propionate, propyl propionate, methyl butyrate, methyl isobutyrate, methyl trimethylacetate, and ethyl trimethylacetate; chain amides such as N,N-dimethylacetamide; chain carbamic acid esters such as methyl N,N-diethylcarbamate and ethyl N,N-diethylcarbamate; and ethers such as 1,2-dimethoxyethane, tetrahydrofuran, tetrahydropyran and 1,3-dioxolane can be used.

In addition, as the non-aqueous electrolytic solution used in the battery of the present application, the high dielectric constant solvents and the low viscosity solvents described above can be used alone or as a mixture of two or more kinds arbitrarily; however, solvents containing 20 to 50% of the cyclic carbonates and 50 to 80% of the low viscosity solvents (low viscosity non-aqueous solvents) are preferable, and solvents having chain carbonates with a boiling point of 130° C. or lower are particularly preferable as the low viscosity solvents.

When a ratio of the cyclic carbonates to the low viscosity solvents deviates from the range above, a dielectric constant decreases when the amount of the low viscosity solvents is too large, and conversely, a viscosity decreases when the amount of the low viscosity solvents is too small; and in either case, there is concern that sufficient conductivity cannot be obtained, leading to failure in obtaining good battery characteristics.

A filling amount of the non-aqueous electrolytic solution into the battery of the present application is desirably in a range of 0.14 to 0.35 g per 1 cm³ of battery capacity. In other words, when the filling amount of the non-aqueous electrolytic solution is less than 0.14 g per unit capacity, a desired battery performance is not obtained, and when the filling amount of the non-aqueous electrolytic solution exceeds 0.35 g, liquid leakage resistance tends to be deteriorated.

Next, an example of a method for manufacturing the battery described above will be explained. To start with, the positive electrode 21 is prepared. In the positive electrode 21, the lithium-cobalt oxide powder, carbon black as a conductive material, and polyvinylidene fluoride as a binder were mixed at a mass ratio of the positive electrode active material : carbon black : polyvinylidene fluoride=96:1:3, and a mixture thereof was charged into N-methylpyrrolidone as a dispersion medium to obtain a mixture slurry. Thereafter, the mixture slurry was applied to the positive electrode current collector 21A made of aluminum having a thickness of 12 μm, dried, and pressurized to form the positive electrode active material layer 21B, thereby preparing the positive electrode.

Next, the negative electrode 22 is prepared. For the negative electrode 22, graphite particles as an active material, a binder (SBR+CMC), and a conductive auxiliary agent were mixed at each weight ratio, and a mixture thereof was diluted with water to prepare a negative electrode slurry. The slurry was uniformly applied onto the copper foil and dried to prepare the electrode. By heat treating the electrode at 200° C., a binding property of the negative electrode active material was improved. The electrode was slit to a width of 80 mm to prepare a non-coated portion, and the tab 12 was attached to the non-coated portion.

Subsequently, after the tab 11 was attached to the positive electrode 21 by welding and the tab 12 was attached to the negative electrode 22 by welding, the separator 24, the positive electrode 21, the same separator 24, and the negative electrode 22 were sequentially laminated and wound, and an oriented polystyrene tape was attached as a winding end tape to the outermost peripheral portion to prepare the wound battery element 20. The wound battery element 20 was pressed at a pressure of 1 N/cm² to adjust a shape. The oriented polystyrene tape was attached to the wound battery element 20 between the tab 11 and the tab 12 on an upper portion of the wound battery element 20 (see FIG. 5) and to a lower portion of the wound battery element 20 (see FIG. 5) so as to cover a thickness direction of the wound battery element 20. In addition, in the present description, the thickness direction means a direction perpendicular to a flat portion 46 and a flat portion 46A of the wound battery element 20.

Furthermore, the wound battery element 20 is sandwiched between the exterior members 30 (30A and 30B), and an outer peripheral edge portion excluding one side is thermally fused to form a bag shape.

Thereafter, the non-aqueous electrolytic solution was prepared, and injected into the wound battery element 20 from a cavity of the exterior members 30, in which the non-aqueous electrolytic solution contains the electrolyte salt such as lithium hexafluorophosphate and the non-aqueous solvent such as ethyl propionate (EP) or propyl propionate (PP). An injected wound battery element 20 was left to stand and impregnated for 48 hours, heated to 60° C., and charged to full charge while being pressurized at 20 kgf/cm² to form an adhesive layer between the separator 24 and the electrodes 21 and 22. Then, the cavity of the exterior members 30 was thermally fused and enclosed. As a result, the battery shown in FIG. 1 and FIG. 2 was completed.

In the battery described above, when charging is performed, the lithium ions are released from the positive electrode active material layer 21B and occluded in the negative electrode active material layer 22B via the non-aqueous electrolytic solution. When discharging is performed, the lithium ions are released from the negative electrode active material layer 22B and occluded in the positive electrode active material layer 21B via the non-aqueous electrolytic solution.

### EXAMPLES

Hereinafter, the present application will be described based on the examples of a drop test and a heating test using the battery prepared as described above according to an embodiment. In addition, the present application is not limited to examples to be explained below.

FIG. 5 is a perspective view of the wound battery element 20. At a position shown in FIG. 5, a tape 41 (an example of a fixing member) was disposed in a U-shape on the side (hereinafter, it is referred to as a top side) from which the tabs 11, 12 of the wound battery element 20 were led out or the side (hereinafter, it is referred to as a bottom side) opposite to the top side, on which the laminated surface of the wound battery element 20 was exposed. The laminated surface means a surface on which the positive electrode 21, the negative electrode 22, and the separator 24 are laminated. An arrangement in the U-shape means that the tape 41 is attached from the flat portion 46 which is a main surface on a front side of the wound battery element 20 to end faces 47 and 47A and the flat portion 46A which is a main surface on a back side, and for example, the tape 41 is attached so as to have the U-shape when viewed from a side surface of the battery. The tape 41 covered a part of the end faces 47 and 47A and a part of the flat portions 46 and 46A in the wound battery element 20. An attachment position (one position) of the tape 41 on the top side is a position between a substantially central position of the end face 47 on the top side and the tabs 11 and 12 of the flat portions 46 and 46A. Attachment positions (two positions) of the tape 41 on the bottom side are positions including left and right of the end face 47A on the bottom side and extension lines of the tabs 11 and 12 of the flat portions 46 and 46A. As the tape 41, a PET tape was used. The PET tape is an adhesive tape containing a PET (polyethylene terephthalate) resin in a substrate.

Further, as shown in FIG. 5, a tape 42 was attached to the flat portion 46 of the wound battery element 20. In addition, a position where the tape 42 is attached is substantially a center of the wound battery element 20, and in the case of the wound battery element 20, it is a position overlapping a winding end portion. The tape 42 was the adhesive tape (the oriented polystyrene tape) using oriented polystyrene as the substrate. The oriented polystyrene tape is 3052DR manufactured by Tapex. The wound battery element 20 to which the tapes 41 and 42 were attached was covered with the exterior members 30, and the wound battery element 20 and the exterior members 30 were fixed with the tape 42.

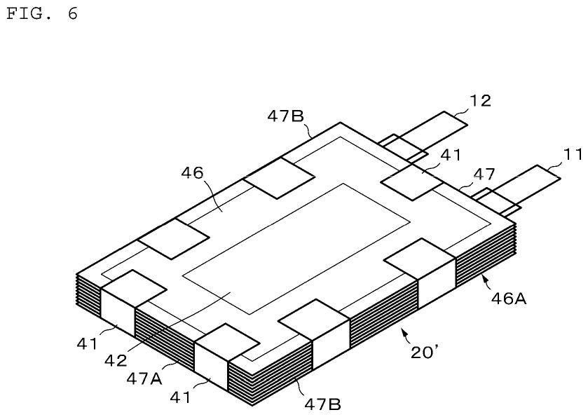

FIG. 6 is a perspective view of the laminated battery element 20′. At a position shown in FIG. 6, the tape 41 was disposed in the U-shape on the top side, the bottom side, and the lateral side (Both sides in a width direction of the tabs 11, 12 between the top side and the bottom side) of the laminated battery element 20′, and on the end face where the laminated surface of the laminated battery element 20′ was exposed. Similarly to the wound battery element 20, the tape 42 was attached to substantially a center of the flat portion 46 in the laminated battery element 20′. The tape 41 covered a part of the end faces 47, 47A, and 47B and a part of the flat portions 46 and 46A of the laminated battery element 20′. An attachment position (one position) of the tape 41 on the top side is a position between a substantially central position of the end face 47 on the top side and the tabs 11 and 12 of the flat portions 46 and 46A. The attachment positions (two positions) of the tape 41 on the bottom side are positions including left and right of the end face 47A on the bottom side and extension lines of the tabs 11 and 12 of the flat portions 46 and 46A. The attachment positions (four positions) of the tape 41 on the lateral side are two positions close to the top side and the bottom side in one end face 47B on the lateral side, and positions including a part of the flat portions 46 and 46A.

In addition, the tape 41 does not necessarily cover entire surfaces of the end faces 47, 47A, and 47B, but covers a part of the end faces 47, 47A, and 47B. As a result, this makes it possible to ensure a circulation of the non-aqueous electrolytic solution from the top side and the bottom side, and to enhance charge/discharge characteristics of the battery. Similarly, the tape 42 was attached to the flat portion 46 of the laminated battery element 20′.

The oriented polystyrene tape used as the tape 42 is wetted with the non-aqueous electrolyte contained in the exterior members 30 to develop a predetermined adhesive force, and can be fixed between the wound battery element 20 or the laminated battery element 20′ and the exterior members 30. Accordingly, the tape 41 in the embodiment has the adhesive force in at least a part, and fixes the wound battery element 20 or the laminated battery element 20′ and the exterior members 30. In addition, since the tabs 11 and 12 are fixed to the exterior members 30 with a sealant interposed therebetween on the top side of the wound battery element 20 or the laminated battery element 20′, the exterior members 30 and the wound battery element 20 or the laminated battery element 20′ are sufficiently fixed when the tape 41 having the adhesive force is attached to at least one of the attachment positions on the bottom side. In addition, it is preferable that the tape 41 having the adhesive force is attached to the attachment position on the top side since a fixing force between the exterior members 30 and the wound battery element 20 or the laminated battery element 20′ on the top side is further increased.

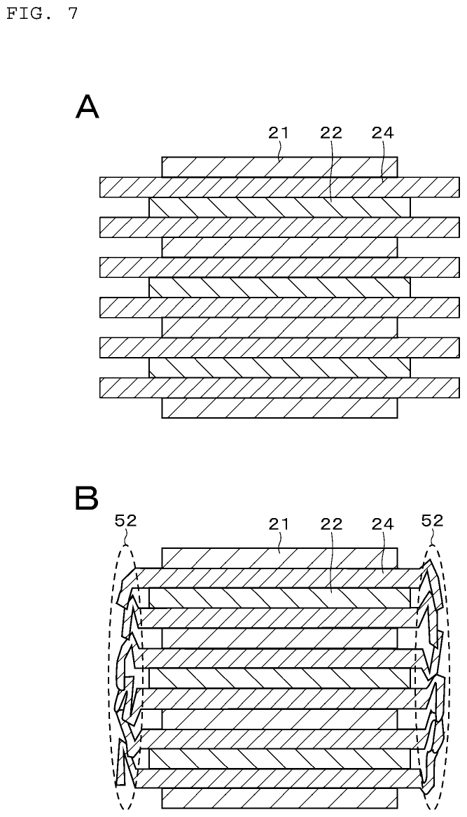

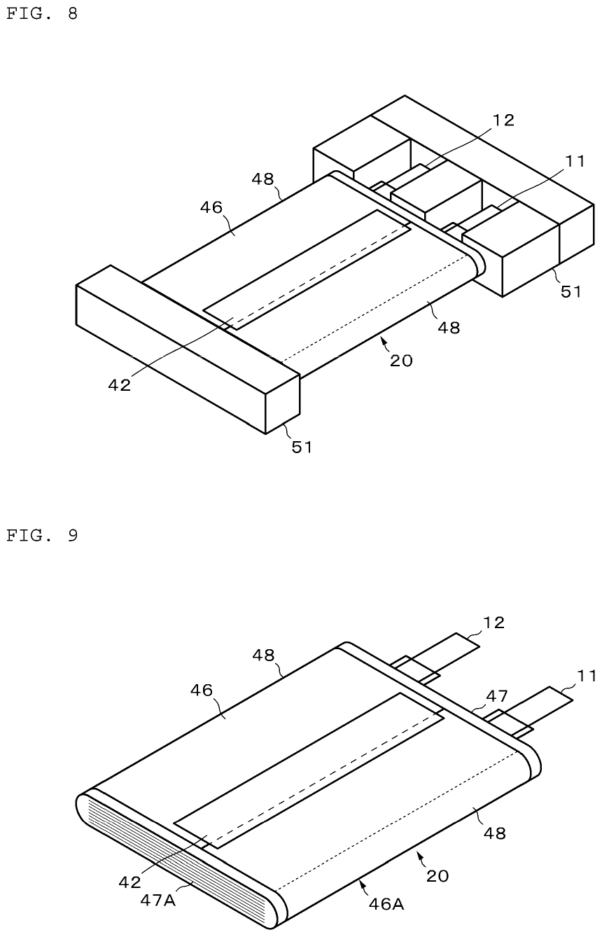

In the examples below, a microporous polyethylene film was used for the separator 24. Further, before the tape 41 or the like was attached, a part or all of the separator 24 of the end faces 47 and 47A of the wound battery element 20 or of the end faces 47, 47A, and 47B of the laminated battery element 20′ were fused. As shown in FIG. 7A, before the separator 24 is fused, the separator 24 protrudes from the end portion of the positive electrode 21 and the end portion of the negative electrode 22 of the wound battery element 20 or the laminated battery element 20′. For example, as shown in FIG. 8, a heater block 51 having a surface temperature of 170° C. was pressed against the end portion of the separator 24 of the wound battery element 20 for 1 second to fuse the end portion of the separator 24 by heat treating. After the fusion, a fusion portion 52 is provided on the end faces 47 and 47A (in a case of the laminated battery element 20′, the end faces 47, 47A, and 47B). The fusion portion 52 is a portion where a position or all of the separator 24 protruding from the ends of the positive electrode 21 and the negative electrode 22 of the wound battery element 20 or the laminated battery element 20′ is melted by heat of the heater block 51 and ends of the separator 24 are connected to each other at a position as indicated by a chain line in FIG. 7B. In a case of the laminated battery element 20′, the end faces (the end face 47B) other than the end faces 47, 47A are mutually fixed by the fusion portion 52. In a case of the wound battery element 20, the separator 24 is positioned and fixed by a winding R portion 48, which is a position where a laminate of the positive electrode 21, the negative electrode 22, and the separator 24 is curved. In other words, fixing here includes fixing by the fusion and positioning and fixing by the winding R portion 48.

Since the fusion portion 52 of the separator is provided in addition to the tape 41 and the tape 42, it is considered that the wound battery element 20 or the laminated battery element 20′ is more strongly fixed in a smartphone and becomes strong against impact due to falling and the like. However, when the fusion portion 52 is provided on all the end faces in order to improve the impact resistance, it is considered as a concern that the heat resistance may be lowered. This matter was examined based on the examples and the comparative examples below. First, an example of the battery including the wound battery element 20 will be explained.

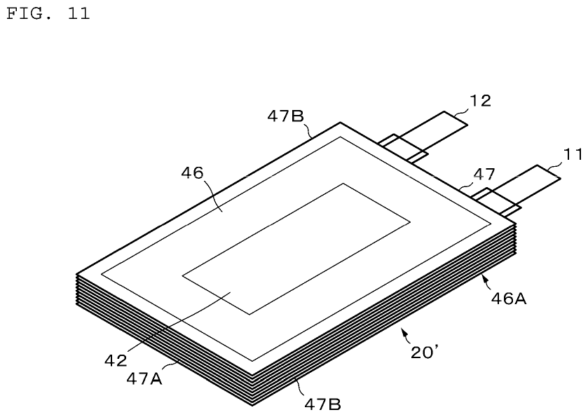

In the examples and the comparative examples below, in order to facilitate understanding, a position of the fusion portion 52 will be explained with reference to FIG. 10A to FIG. 10F and FIG. 12A to FIG. 12F. In addition, FIG. 10A to FIG. 10F are plan views of the wound battery element 20, and FIG. 12 to FIG. 12F are plan views of the laminated battery element 20′. In FIG. 10A to FIG. 10F and FIG. 12A to FIG. 12F, the fusion portion 52 of the separator 24 is indicated by a thick line, and the tape 41 is omitted in the drawings.

### Example 1

As shown in FIG. 10A, the fusion portion 52 was provided on an entire end face 47A and a part of the end face 47 of the wound battery element 20 at a position excluding peripheries of the tabs 11 and 12. As shown in FIG. 5, the tape 41 was attached in the U-shape.

### Example 2

As shown in FIG. 10B, the fusion portion 52 was provided on the end face 47 of the wound battery element 20 at a position excluding the peripheries of the tabs 11 and 12, and the fusion portion 52 was not provided on the end face 47A. As shown in FIG. 5, the tape 41 was attached in the U-shape.

### Example 3

As shown in FIG. 10C, the fusion portion 52 was not provided on the end face 47 of the wound battery element 20, and the fusion portion 52 was provided on the entire end face 47A. As shown in FIG. 5, the tape 41 was attached in the U-shape.

### Comparative Example 1

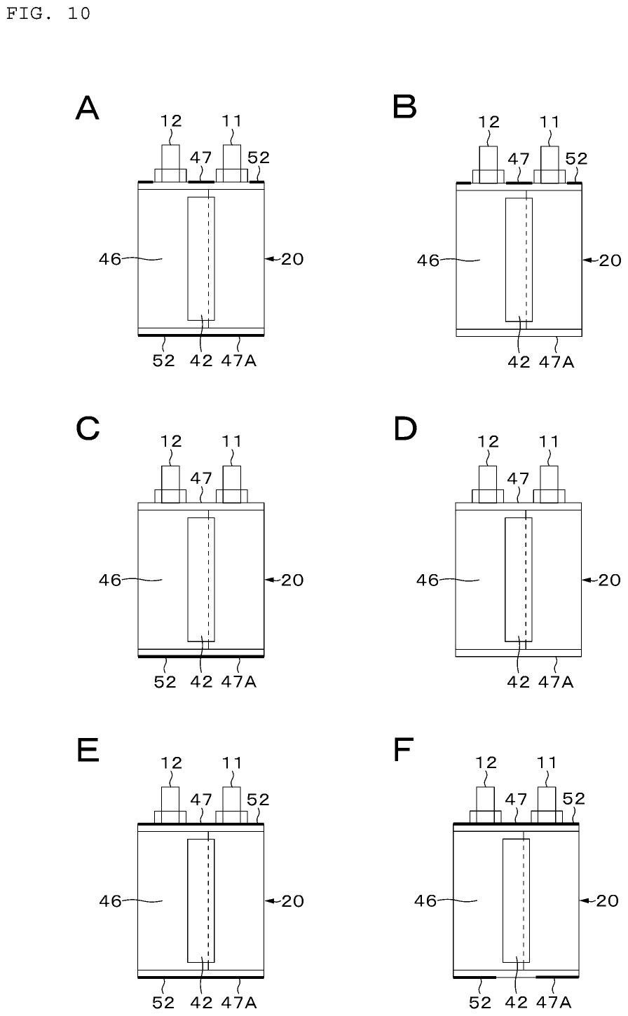

As shown in FIG. 9, the configuration was similar to that in Example 1 except that the tape 41 was not attached in the U-shape.

### Comparative Example 2

As shown in FIG. 9, the configuration was similar to that in Example 2 except that the tape 41 was not attached in the U-shape.

### Comparative Example 3

As shown in FIG. 9, the configuration was similar to that in Example 3 except that the tape 41 was not attached in the U-shape.

### Comparative Example 4

As shown in FIG. 10D, the fusion portion 52 was not provided on the end faces 47 and 47A of the wound battery element 20. As shown in FIG. 5, the tape 41 was attached in the U-shape.

### Comparative Example 5

As shown in FIG. 9, the configuration was similar to that in Comparative Example 4 except that the tape 41 was not attached in the U-shape.

### Comparative Example 6

As shown in FIG. 10E, the fusion portion 52 was provided on the entire end faces 47 and 47A of the wound battery element 20. As shown in FIG. 5, the tape 41 was attached in the U-shape.

### Comparative Example 7

As shown in FIG. 9, the procedure was similar to that in Comparative Example 6 except that the tape 41 was not attached in the U-shape.

### Comparative Example 8

As shown in FIG. 10F, the fusion portion 52 was provided on the entire end face 47 of the wound battery element 20, and the fusion portion 52 was provided at a position other than a central portion of the end face 47A. As shown in FIG. 5, the tape 41 was attached in the U-shape.

In addition, Examples 1 to 3 and Comparative Examples 1 to 8 are examples in which there was no separator protruding from end faces not belonging to either the end face 47 or the end face 47A.

Evaluation

The drop test and the heating test were performed on the examples and the comparative examples above. The drop test is a test using a rotary drum tester, in which a jig simulating the smartphone including the battery described above is dropped from a height of 1 m within the tester. The jig having the same size and the same weight as the smartphone was prepared, the battery was installed on the jig, and the drop test was performed. The drop test was repeated, and a state of the battery was examined every 50 times; a case where the exterior member 30 was damaged, a case where a voltage was 3 V or less due to an internal short circuit, a case where an impedance measurement was impossible due to a rupture of the tabs 11 and 12, and a case where a temperature abnormality occurred were determined as NG on an assumption that the smartphone was not operated or the smartphone was shut down; and the number of times that NG was determined was defined as the number of drop tests. The drop test was determined as OK when the number of drop tests was 500 or more, and as NG when the number of drop tests was less than 500. The heating test is a test in which a temperature of a thermostatic bath is increased from an environment of 20±5° C. at a temperature rise rate of 5° C./min±2° C./min in the thermostatic bath, and when the temperature reaches a test temperature (any of 132° C., 135° C., 137° C., 140° C., 142° C., 145° C., and 150° C.), the temperature is maintained at the test temperature for 60 minutes to examine whether the thermal runaway occurs in the battery. The number of tests was 5 for each temperature of each example, and a case where three or more thermal runaways occurred was determined as NG, and a case where less than three thermal runaways occurred was determined as OK. Results are shown in Table 1.

TABLE 1

| | Figure showing | | | | | | | | | Drop test | |
|---|---|---|---|---|---|---|---|---|---|---|---|
| | position of | Tape 41 | Heating test | | | | | | | Number of | |
| | fusion portion | (Yes or No) | 132° C. | 135° C. | 137° C. | 140° C. | 142° C. | 145° C. | 150° C. | drop tests | Determination |
| Example 1 | FIG. 10A | Yes | OK | OK | OK | OK | OK | OK | NG | 1150 | OK |
| Example 2 | FIG. 10B | Yes | OK | OK | OK | OK | NG | NG | NG | 750 | OK |
| Example 3 | FIG. 10C | Yes | OK | OK | OK | OK | NG | NG | NG | 650 | OK |
| Comparative | FIG. 10A | No | OK | OK | OK | OK | NG | NG | NG | 100 | NG |
| Example 1 | | | | | | | | | | | |
| Comparative | FIG. 10B | No | OK | OK | OK | OK | NG | NG | NG | 150 | NG |
| Example 2 | | | | | | | | | | | |
| Comparative | FIG. 10C | No | OK | OK | OK | OK | NG | NG | NG | 150 | NG |
| Example 3 | | | | | | | | | | | |
| Comparative | FIG. 10D | Yes | OK | OK | OK | NG | NG | NG | NG | 400 | NG |
| Example 4 | | | | | | | | | | | |
| Comparative | FIG. 10D | No | OK | OK | OK | NG | NG | NG | NG | 200 | NG |
| Example 5 | | | | | | | | | | | |
| Comparative | FIG. 10E | Yes | OK | OK | NG | NG | NG | NG | NG | 1150 | OK |
| Example 6 | | | | | | | | | | | |
| Comparative | FIG. 10E | No | OK | OK | NG | NG | NG | NG | NG | 200 | NG |
| Example 7 | | | | | | | | | | | |
| Comparative | FIG. 10F | Yes | OK | OK | NG | NG | NG | NG | NG | 1200 | OK |
| Example 8 | | | | | | | | | | | |

In Examples 1 to 3 (the examples in which the fusion portion 52 was provided on at least one of the one end face 47 and the other end face 47A of the separator 24, and the tape 41 was attached in the U-shape), a temperature at which a result of the heating test was OK was as relatively high as 140° C. or higher, and a result of the drop test was also OK. This is considered that, since there was no fusion portion 52 around the tabs 11 and 12, a gas generated inside the wound battery element 20 during heating was released from the end face 47 to outside, so that the temperature at which the result of the heating test was OK became relatively high. Further, it is considered that, since the tape 41 was attached, the wound battery element 20 was sufficiently fixed, and the result of the drop test was OK.

On the other hand, in Comparative Examples 1 to 3, the results of the drop test was NG. This is considered that, since the tape 41 was not attached, the wound battery element 20 was sufficiently fixed, and the result of the drop test was NG.

Further, in Comparative Examples 4 and 5 in which the fusion portion 52 was not provided, the results were NG in both the heating test and the drop test. This is considered that, since the fusion portion 52 was not provided, a strength against dropping was insufficient, and thus the drop test was NG. Further, it was considered that, since the fusion portion 52 was not provided, the separator 24 shrinks toward an inside of the wound battery element 20 by heating, so that the short circuit easily occurs and the heating test is NG.

Further, in Comparative Examples 6 to 8 in which the fusion portion 52 was provided on the entire end face 47, the temperature at which the heating test was OK was as relatively low as 135° C. This is considered that, in Comparative Examples 6 to 8, since the fusion portion 52 also existed around the tabs 11 and 12, the gas generated inside the wound battery element 20 during heating was not released from the end face 47, and the temperature at which the heating test was OK was relatively low.

As described above, when the wound battery element 20 adopts any configuration corresponding to Examples 1 to 3, specifically, when the separator 24 protruding from at least one of the end face 47 or the other end face 47A located on the other side with respect to the end face 47 is mutually fused with the end face, the separator 24 located around the tabs 11 and 12 of the end face 47 is not mutually fused with the end face, and the tape 41 is disposed on the end faces 47 and 47A where the laminated surface of the wound battery element 20 is exposed, the battery having high impact resistance and high heat resistance can be realized.

Next, the battery including the laminated battery element 20′ will be described. In addition, Examples 4 and 5 and Comparative Examples 9 to 17 are examples in which there is a separator protruding from the end face (the end face 47B) not belonging to either the end face 47 or the end face 47A.

### Example 4

As shown in FIG. 12A, the fusion portion 52 was provided on the end face 47 of the laminated battery element 20′ on the entire end faces 47A and 47B and at a position excluding the peripheries of the tabs 11 and 12. Further, as shown in FIG. 6, the tape 41 was attached in the U-shape.

### Example 5

As shown in FIG. 12B, the fusion portion 52 was not provided on the end face 47 of the laminated battery element 20′, and the fusion portion 52 was provided on all of the end faces 47A and 47B. Further, as shown in FIG. 6, the tape 41 was attached in the U-shape.

### Comparative Example 9

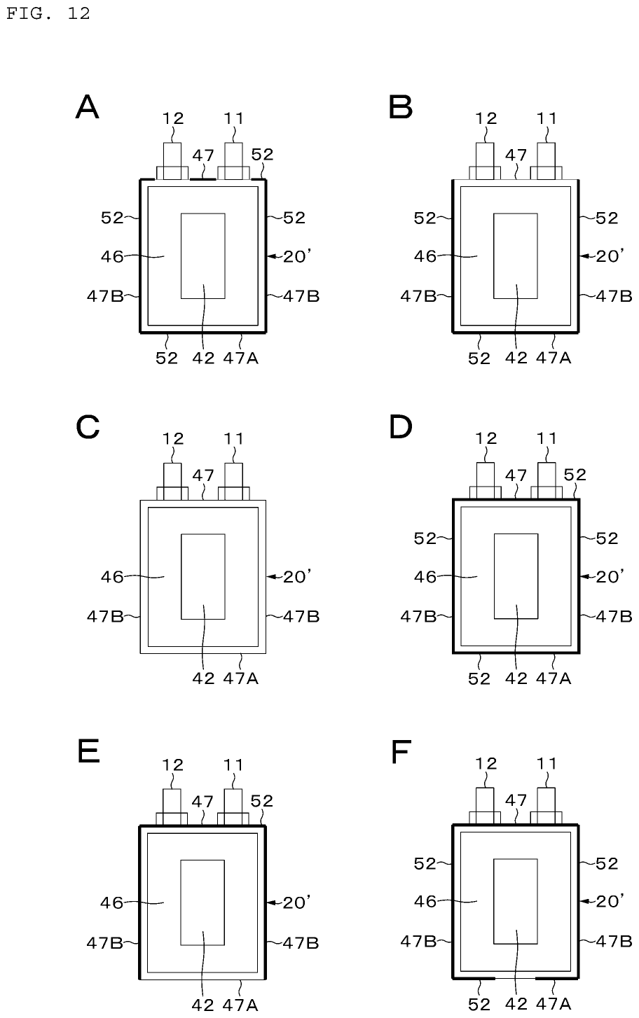

As shown in FIG. 11, the configuration was similar to that in Example 4 except that the tape 41 was not attached in the U-shape.

### Comparative Example 10

As shown in FIG. 11, the configuration was similar to that in Example 5 except that the tape 41 was not attached in the U-shape.

### Comparative Example 11

As shown in FIG. 12C, the fusion portion 52 was not provided on the end faces 47, 47A, and 47B of the laminated battery element 20′. Further, as shown in FIG. 6, the tape 41 was attached in the U-shape.

### Comparative Example 12

As shown in FIG. 11, the configuration was similar to that in Comparative Example 11 except that the tape 41 was not attached in the U-shape.

### Comparative Example 13

As shown in FIG. 12D, the fusion portion 52 was provided on all of the end faces 47, 47A, and 47B of the laminated battery element 20′. Further, as shown in FIG. 6, the tape 41 was attached in the U-shape.

### Comparative Example 14

As shown in FIG. 11, the configuration was similar to that in Comparative Example 13 except that the tape 41 was not attached in the U-shape.

### Comparative Example 15

As shown in FIG. 12E, the fusion portion 52 was provided on all of the end faces 47 and 47B of the laminated battery element 20′, and the fusion portion 52 was not provided on the end face 47A. Further, as shown in FIG. 6, the tape 41 was attached in the U-shape.

### Comparative Example 16

As shown in FIG. 11, the configuration was similar to that in Comparative Example 15 except that the tape 41 was not attached in the U-shape.

### Comparative Example 17

As shown in FIG. 12F, the fusion portion 52 was provided on all of the end faces 47 and 47B of the laminated battery element 20′, and the fusion portion 52 was provided at a position other than the central portion of the end face 47A. Further, as shown in FIG. 6, the tape 41 was attached in the U-shape.

Evaluation

The drop test and the heating test were performed on Examples 4 to 5 and Comparative Examples 9 to 17. Both tests were performed in a same manner as described above. Results are shown in Table 2.

TABLE 2

| | Figure showing | | | | | | | | | Drop test | |
|---|---|---|---|---|---|---|---|---|---|---|---|
| | position of | Tape 41 | Heating test | | | | | | | Number of | |
| | fusion portion | (Yes or No) | 132° C. | 135° C. | 137° C. | 140° C. | 142° C. | 145° C. | 150° C. | drop tests | Determination |
| Example 4 | FIG. 12A | Yes | OK | OK | OK | OK | OK | NG | NG | 1050 | OK |
| Example 5 | FIG. 12B | Yes | OK | OK | OK | OK | NG | NG | NG | 550 | OK |
| Comparative | FIG. 12A | No | OK | OK | NG | NG | NG | NG | NG | 100 | NG |
| Example 9 | | | | | | | | | | | |
| Comparative | FIG. 12B | No | OK | OK | NG | NG | NG | NG | NG | 100 | NG |
| Example 10 | | | | | | | | | | | |
| Comparative | FIG. 12C | Yes | OK | OK | NG | NG | NG | NG | NG | 300 | NG |
| Example 11 | | | | | | | | | | | |
| Comparative | FIG. 12C | No | OK | OK | NG | NG | NG | NG | NG | 150 | NG |
| Example 12 | | | | | | | | | | | |
| Comparative | FIG. 12D | Yes | OK | NG | NG | NG | NG | NG | NG | 1100 | OK |
| Example 13 | | | | | | | | | | | |
| Comparative | FIG. 12D | No | OK | NG | NG | NG | NG | NG | NG | 100 | NG |
| Example 14 | | | | | | | | | | | |
| Comparative | FIG. 12E | Yes | OK | OK | NG | NG | NG | NG | NG | 550 | OK |
| Example 15 | | | | | | | | | | | |
| Comparative | FIG. 12E | No | OK | OK | NG | NG | NG | NG | NG | 100 | NG |
| Example 16 | | | | | | | | | | | |
| Comparative | FIG. 12F | Yes | OK | OK | NG | NG | NG | NG | NG | 1200 | OK |
| Example 17 | | | | | | | | | | | |

In Examples 4 and 5 (the Examples in which the fusion portion 52 was provided on any one of the end face 47 or the other end face 47A located on the other side with respect to the end face 47, and the end face 47B not belonging to any one of the end face 47 and the other end face 47A, and the tape 41 was attached in the U-shape), the temperature at which the heating test was OK was as relatively high as 140° C. or higher, and the result of the drop test was also OK. This is considered that, since the fusion portion 52 was not provided around the tabs 11 and 12, the gas generated inside the laminated battery element 20′ during heating was discharged to outside from the portion where the fusion portion 52 was not provided around the tabs 11 and 12, and thus the temperature at which the heating test was OK was relatively high. Further, since the tape 41 was attached, the laminated battery element 20′ was sufficiently fixed, and it is considered that the result of the drop test was OK.

On the other hand, in Comparative Example 9 and Comparative Example 10, the result of the drop test was NG. This is considered that, since the tape 41 was not attached, the laminated battery element 20′ was sufficiently fixed, and the result of the drop test was NG.

In Comparative Example 11 and Comparative Example 12, the result of the drop test was NG. This is considered that, since the fusion portion 52 was not provided, the impact resistance was reduced, and the result of the drop test was NG.

In Comparative Example 13 and Comparative Example 14, the temperature at which the result of the heating test was OK was as low as 132° C. This is considered that, since the fusion portion 52 was also around the tabs, the gas generated inside the laminated battery element 20′ during heating was not released from the end face 47, and the temperature at which the heating test was OK was relatively low.

In Comparative Examples 15 to 17, the temperature at which the result of the heating test was OK was as low as 135° C. This is considered that, since the fusion portion 52 was also around the tabs, the gas generated inside the laminated battery element 20′ during heating was not released from the end face 47, and the temperature at which the heating test was OK was relatively low. Further, in Comparative Example 16, the result of the drop test was NG. This is considered that, since the tape 41 was not attached, the laminated battery element 20′ was sufficiently fixed, and the result of the drop test was NG.

As described above, when the laminated battery element 20′ adopts the configuration of Example 4 or Example 5, that is, when at least one of the one end face 47 or the other end face 47A located on the other side with respect to the one end face 47 and the separator 24 protruding from the end face 47B not belonging to either the one end face 47 or the other end face 47A are mutually fused, the separator 24 located around the tabs 11 and 12 of the end face 47 is not mutually fused with the end face, and the tape 41 is disposed on the end faces 47, 47A, and 47B where the laminated surface of the laminated battery element 20′ is exposed, the battery having both high impact resistance and high heat resistance can be realized.

Although the present application has been described above, the contents of the present application are not limited thereto, and various modifications thereof are possible.

Although the tape 41 was the PET tape, the tape 41 may be the oriented polystyrene tape. A size of the battery may be appropriately changed.

The configurations, methods, steps, shapes, materials, numerical values, and the like described herein are merely examples, and configurations, methods, steps, shapes, materials, numerical values, and the like different from these may be used as necessary. The subject matter relating to the present application described herein can be appropriately combined according to an embodiment.

### DESCRIPTION OF REFERENCE SYMBOLS

11, 12: Tab

20: Wound battery element

20′: Laminated battery element

30, 30A, 30B: Exterior member

41: Tape

42: Tape

46, 46A: Flat portion

47, 47A, 47B: End face

48: Winding R portion

52: Fusion portion

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a battery element in which a positive electrode and a negative electrode are laminated with a separator interposed therebetween;
a fixing member disposed on an end face where the laminated surface of the battery element is exposed; and
a tab led out from one end face of the battery element;
wherein the separator protrudes from the end face of the battery element;
the separator is mutually fused with at least a protruding portion of one of the one end face or another end face opposite to the one end face; and
the separator positioned around the tab on the one end face is not mutually fused with the one end face.

2. The battery according to claim 1, wherein the separator on an end face other than the one end face and the other end face of the battery element is mutually fixed.

3. The battery according to claim 2 , wherein the separator protruding from the one end face and the other end face is mutually fused with the end face.

4. The battery according to claim 1, wherein the fixing member is attached in a U-shape.
